(19) United States
(12) Patent Application Publication
(10) Pub. No.: US 2025/0182182 A1
(43) Pub. Date: Jun. 5, 2025

(54) SCREENING METHOD FOR ASSOCIATED OBJECTS AND METHOD FOR RECOMMENDING SAME STYLE PRODUCTS

(71) Applicant: Hangzhou Alibaba International Internet Industry Co., Ltd., Hangzhou (CN)

(72) Inventors: Ronggang Dou, Beijing (CN); Kai Liu, Beijing (CN); Rongxun Zhao, Beijing (CN)

(21) Appl. No.: 18/919,769

(22) Filed: Oct. 18, 2024

(30) Foreign Application Priority Data
Nov. 30, 2023 (CN) 202311631879.5

(51) Int. Cl. G06Q 30/0601; G06F 16/56

(52) U.S. Cl. CPC G06Q 30/0631; G06F 16/56

(57) ABSTRACT

The application provides methods for screening associated objects and recommending same style products. The method for screening associated objects includes: obtaining a first feature vector set corresponding to a first object and at least one second feature vector set corresponding to at least one second object; determining an object similarity between the first object and the second object based on multiple vector similarities between the feature vectors in the first feature vector set and the feature vectors in the second feature vector set, wherein the multiple vector similarities include vector similarity between the image feature vectors and the text feature vectors; and screening the at least one second object based on the object similarity to obtain an associated object of the first object. The solution proposed by this application improves the accuracy of determining object similarity, thereby allowing for more precise screening of the associated objects for the first object.

### CROSS-REFERENCE TO RELATED APPLICATIONS

This application claims priority to Chinese Patent Application No. 202311631879.5, filed with the China National Intellectual Property Administration on Nov. 30, 2023, and entitled “Screening Method for Associated Objects and Method for Recommending Same Style Products,” which is incorporated herein by reference in its entirety.

### TECHNICAL FIELD

The present application relates to the field of computer technology, particularly to a method for screening associated objects and a method for recommending same style products.

### BACKGROUND

When people encounter objects such as products or exhibits, they often want to further explore associated objects to compare them with the current object. Taking the example of people using e-commerce platforms to purchase products, during the shopping process, when viewing a product, users typically wish to find same style products. This allows them to compare the current product with the same style ones in terms of price, color, quality, and functionality, ultimately determining whether the current product is more suitable for purchase and thus making an informed decision on whether to buy the current product.

Therefore, the question of how to obtain associated objects has become a technical problem that professionals in the relevant field urgently need to address.

### SUMMARY

The embodiments of the present application provide a method for screening associated objects and a method for recommending same style products, aimed at resolving one or more of the aforementioned technical problems.

In a first aspect, the embodiments of the present application provide a method for screening associated objects, the method comprising:
obtaining a first feature vector set corresponding to a first object, and at least one second feature vector set corresponding to at least one second object; wherein the feature vector set records image feature vectors corresponding to object images that include the objects, and text feature vectors corresponding to key characteristic description text that describes key characteristics of the objects, and wherein the image feature vectors and the text feature vectors correspond to the same feature space;
determining an object similarity between the first object and the second object based on multiple vector similarities between the feature vectors in the first feature vector set and the feature vectors in the second feature vector set, wherein the multiple vector similarities include the vector similarity between the image feature vectors and the text feature vectors;
screening the at least one second object based on the object similarity to obtain an associated object of the first object.

In a second aspect, the embodiments of the present application provide a method for recommending same style products, the method comprising:
in response to a product recommendation request for a first product, obtaining a first feature vector set corresponding to the first product, and at least one second feature vector set corresponding to at least one second product; wherein the feature vector set records image feature vectors corresponding to product images that include the products and text feature vectors corresponding to product titles that describe the products, and wherein the image feature vectors and the text feature vectors correspond to the same feature space;
determining the product similarity between the first product and the second product based on multiple vector similarities between the feature vectors in the first feature vector set and the feature vectors in the second feature vector set, wherein the multiple vector similarities include the vector similarity between the image feature vectors and the text feature vectors;
screening the at least one second product based on the product similarity to obtain a same style product of the first product;
displaying the same style product in the product recommendation interface.

In a third aspect, the embodiments of the present application provide another method for recommending same style products, the method comprising:
in response to a same style product provision request sent by a merchant for a first product, obtaining a first feature vector set corresponding to the first product and at least one second feature vector set corresponding to at least one second product; wherein the feature vector set records image feature vectors corresponding to product images that include the products, and text feature vectors corresponding to product titles that describe the products, and wherein the image feature vectors and the text feature vectors correspond to the same feature space;
determining the product similarity between the first product and the second product based on multiple vector similarities between the feature vectors in the first feature vector set and the feature vectors in the second feature vector set, wherein the multiple vector similarities include vector similarity between the image feature vectors and the text feature vectors;
screening the at least one second product based on the product similarity to obtain a same style product of the first product;
providing the same style product to the merchant.

In a fourth aspect, the embodiments of the present application provide an electronic device, comprising a memory, a processor, and a computer program stored in the memory, wherein the processor, when executing the computer program, implements the method provided by any of the embodiments of the present application.

In a fifth aspect, the embodiments of the present application provide a computer-readable storage medium, wherein the computer-readable storage medium stores a computer program, and the computer program, when executed by a processor, implements the method provided by any of the embodiments of the present application.

Compared with the prior art, the present application has the following advantages:
in the technical solution of the present application, since the image feature vectors and text feature vectors in the feature vector set correspond to the same feature space, it becomes possible to calculate the vector similarity between the image feature vector corresponding to one object and the text feature vector corresponding to another object. In this way, when determining the object similarity between the first object and the second object using multiple vector similarities between the feature vectors in the first feature vector set and the feature vectors in the second feature vector set, the vector similarity between the image feature vectors and the text feature vectors can also be included.

Therefore, in the technical solution of the present application, when determining object similarity, not only can the vector similarity between the image feature vectors of two objects and the vector similarity between the text feature vectors of two objects be utilized, but the vector similarity between the image feature vector and the text feature vector can also be employed. Since the image feature vector characterizes the object image that includes the object, and the text feature vector characterizes the key characteristic description text that describes the key features of the object, determining object similarity using the vector similarity between the image feature vectors of two objects, the vector similarity between the text feature vectors of two objects, and the vector similarity between the image feature vector and the text feature vector can be regarded as using the similarity between the object images of the two objects, the similarity between the key characteristic description texts of the two objects, and the similarity between the object image of one object and the key characteristic description text of the other object. By determining object similarity based on the combination of image similarity, text similarity, and cross-modal similarity, the determined object similarity will have higher accuracy, which in turn allows for more precise screening of the associated objects of the first object.

The above summary is provided merely for illustrative purposes and is not intended to limit the application in any way. In addition to the exemplary aspects, embodiments, and features described above, further aspects, embodiments, and features of the present application will become apparent by referring to the accompanying drawings and the detailed description that follows.

### BRIEF DESCRIPTION OF THE DRAWINGS

In the drawings, unless otherwise specified, the same reference numerals are used across multiple figures to denote the same or similar components or elements. These drawings are not necessarily drawn to scale. It should be understood that these drawings depict only some embodiments disclosed in the present application and should not be considered as limiting the scope of the application.

FIG. 1 illustrates a schematic diagram of an application scenario of a method for screening associated objects provided in an embodiment of the present application;

FIG. 2 illustrates a schematic diagram of another application scenario of a method for screening associated objects provided in an embodiment of the present application;

FIG. 3 illustrates a flowchart of a method for screening associated objects provided in an embodiment of the present application;

FIG. 4 illustrates a flowchart of a method for recommending same style products provided in an embodiment of the present application;

FIG. 5 illustrates a flowchart of another method for recommending same style products provided in an embodiment of the present application;

FIG. 6 illustrates a schematic diagram of a device for screening associated objects provided in an embodiment of the present application.

FIG. 7 illustrates a schematic diagram of a device for recommending same style products provided in an embodiment of the present application;

FIG. 8 illustrates a schematic diagram of another device for recommending same style products provided in an embodiment of the present application; and

FIG. 9 illustrates a block diagram of an electronic device used to implement the embodiments of the present application.

### DETAIL DESCRIPTION OF THE EMBODIMENTS

Numerous specific details are set forth in the following description to provide a thorough understanding of the present application. However, the present application can be implemented in many forms other than those described herein, and those skilled in the art may make similar generalizations without departing from the spirit of the present application. Therefore, the present application is not limited to the specific embodiments disclosed below.

To facilitate understanding of the technical solutions in the embodiments of the present application, the related technologies of the embodiments are explained below. These related technologies can be optionally combined with the technical solutions of the embodiments of the present application in any manner, all of which fall within the scope of protection of the embodiments of the present application. The embodiments of the present application involve a screening solution for associated objects. In this screening solution, a first feature vector set corresponding to a first object and at least one second feature vector set corresponding to at least one second object are first obtained. Then, multiple vector similarities between the feature vectors in the first feature vector set and the feature vectors in the second feature vector set are utilized. Finally, Screening the at least one second object based on the object similarity to obtain an associated object of the first object.

In the embodiments of the present application, the feature vector set records the image feature vectors corresponding to the object images that include the objects, as well as the text feature vectors corresponding to the key characteristic description texts that describe the key characteristics of the objects. Additionally, the image feature vectors and the text feature vectors correspond to the same feature space. Moreover, among the multiple vector similarities used to determine the object similarity, the vector similarity between the image feature vectors and the text feature vectors is also included.

Since the image feature vectors and text feature vectors in the feature vector set correspond to the same feature space, it becomes possible to calculate the vector similarity between the image feature vector of one object and the text feature vector of another object. In this way, when determining the object similarity between the first object and the second object using multiple vector similarities between the feature vectors in the first feature vector set and the feature vectors in the second feature vector set, the vector similarity between the image feature vectors and the text feature vectors can also be included in the process.

It can be seen that in the screening solution for associated objects in the embodiments of the present application, when determining object similarity, not only can the vector similarity between the image feature vectors of two objects and the vector similarity between the text feature vectors of two objects be utilized, but also the vector similarity between the image feature vectors and the text feature vectors. Since the image feature vector represents the object image that includes the object, and the text feature vector represents the key characteristic description text that describes the object's key characteristics, determining object similarity using the vector similarity between the image feature vectors of two objects, the vector similarity between the text feature vectors of two objects, and the vector similarity between the image feature vector and the text feature vector can be viewed as determining object similarity based on the similarity between the object images of two objects, the similarity between the key characteristic description texts of two objects, and the similarity between the object image of one object and the key characteristic description text of another object. By combining image similarity, text similarity, and cross-modal similarity to determine object similarity, the resulting object similarity is more accurate, thereby allowing for more precise screening of the associated objects of the first object.

The object generally refers to a product but can also refer to an exhibit, such as a sculpture, or even food, such as bread. Specifically, in the embodiments of the present application, the type of object is not limited. The second object is typically of the same type as the first object. In one example, the first object is a pair of Martin boots, and the second object is also a pair of Martin boots. In another example, the first object is a laptop, and the second object is also a laptop.

An associated object refers to an object that has the same or similar form, style, design features, or functionality as the first object. When the object is a product, an associated object refers to a same style product. In one example, the first object is a fleece-lined jacket sold by Merchant A, and in this case, the associated objects could be other fleece-lined jackets sold by Merchant A, as well as fleece-lined jackets sold by other merchants. In this scenario, the common design feature between the first object and the associated objects is the “fleece-lining.” In another example, the first object is a black 5G (5th Generation mobile communication technology)-enabled smartphone C sold by Merchant B, and the associated objects could include a red 5G-enabled smartphone C sold by Merchant B, as well as other 5G-enabled smartphones sold by other merchants. In this scenario, the common functionality between the first object and the associated objects is the “5G communication support.”

Under the premise of having the same or similar form, style, design features, or functionality, the associated object and the first object may be same style in all attributes except for differences in the manufacturer. Similarly, under the same premise, the associated object and the first object may differ in all attributes except for having the same color.

When the object is a product, the key characteristic description text that describes the object's key features generally refers to the product title. Specifically, it is the product title configured by the merchant for the product.

In the embodiments of the present application, the image feature vectors and text feature vectors corresponding to the same feature space means that the image feature vectors and text feature vectors share the same vector dimensions and use the same numerical representation. In one example, both the image feature vectors and text feature vectors are binary vectors with 768 dimensions.

The multiple vector similarities between the feature vectors in the first feature vector set and the feature vectors in the second feature vector set generally include: the vector similarity between the image feature vectors of the two objects, the vector similarity between the text feature vectors of the two objects, and the vector similarity between the image feature vectors and the text feature vectors. The multiple vector similarities between the feature vectors in the first feature vector set and the feature vectors in the second feature vector set may also include: the vector similarity between the text feature vectors of the two objects, and the vector similarity between the image feature vectors and the text feature vectors. Additionally, the multiple vector similarities between the feature vectors in the first feature vector set and the feature vectors in the second feature vector set may include: the vector similarity between the image feature vectors of the two objects, and the vector similarity between the image feature vectors and the text feature vectors.

The vector similarity between the image feature vectors and the text feature vectors refers to the vector similarity between the image feature vector of one object and the text feature vector of another object. Specifically, this may include at least one of the following: the vector similarity between the image feature vector corresponding to the first object and the text feature vector corresponding to the second object, and the vector similarity between the text feature vector corresponding to the first object and the image feature vector corresponding to the second object.

It should be noted that, in order to achieve higher accuracy in determining object similarity, the multiple vector similarities used to determine object similarity must include the vector similarity between the image feature vectors of the two objects, the vector similarity between the text feature vectors of the two objects, and the vector similarity between the image feature vector and the text feature vector. In other words, to achieve higher accuracy in determining object similarity, it is necessary to use the similarity between the object images of the two objects, the similarity between the key characteristic description texts of the two objects, and the similarity between the object image of one object and the key characteristic description text of the other object. Compared to determining object similarity based only on image similarity or text similarity, or even based on both image similarity and text similarity, determining object similarity by combining image similarity, text similarity, and cross-modal similarity results in greater accuracy in determining object similarity, thereby enabling more precise screening of associated objects for the first object.

In order for the image feature vectors and the text feature vectors to correspond to the same feature space, the feature space can be predetermined when obtaining the first feature vector set corresponding to the first object and the second feature vector set corresponding to at least one second object. Then, feature extraction is performed on the object image and the key characteristic description text corresponding to the first object in the predetermined feature space to obtain the image feature vector and the text feature vector corresponding to the first object, thereby constructing the first feature vector set. Similarly, feature extraction is performed on the object image and the key characteristic description text corresponding to the second object in the predetermined feature space to obtain the image feature vector and the text feature vector corresponding to the second object, thereby constructing the second feature vector set. In one example, the vectors in the predetermined feature space are required to be 128-dimensional binary vectors, in which case both the image feature vectors and the text feature vectors are 128-dimensional binary vectors.

To enhance the representational capability of the image feature vectors and text feature vectors while reducing the software and hardware resources required to obtain these vectors, a multimodal image-text model can be used to extract features from the object image and key characteristic description text to obtain the corresponding image feature vector and text feature vector. Since multimodal models can better understand the relationships between images and text, the image feature vectors and text feature vectors obtained through such models have stronger representational capabilities. Moreover, compared to separately training and deploying a neural network model for obtaining image feature vectors and another neural network model for obtaining text feature vectors, using a multimodal image-text model allows both image feature vectors and text feature vectors to be obtained simultaneously through a single model. This approach significantly reduces the software and hardware resources required for model training and deployment.

In one example, the multimodal image-text model used is based on the BLIP (Bootstrapping Language-Image Pretraining) 2 multimodal model, which unifies understanding and generation. It should be noted that in the embodiments of the present application, the version, type, and other specifics of the multimodal image-text model are not particularly limited.

To more clearly demonstrate the method for screening associated objects provided in the embodiments of the present application, an application example of this method will be introduced first. The method for screening associated objects provided in the embodiments of the present application can be applied to the recommendation of same style products. When applying the method for screening associated objects to the recommendation of same style products, both the first object and the second object are products. Specifically, the first object can be referred to as the first product, and the second object as the second product. Moreover, an associated object refers to a same style product, and when the object is a product, the key characteristic description text that describes the object generally refers to the product title.

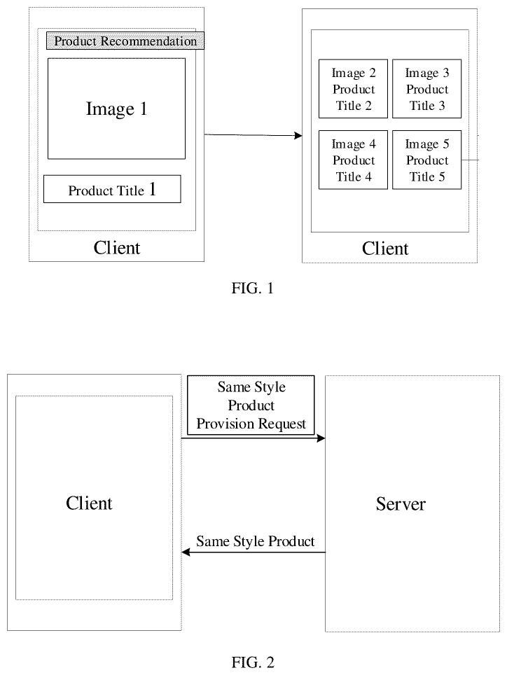

In the embodiments of the present application, the method for screening associated objects provided can be applied to the recommendation of same style products on the client side. In this case, the implementation process of the method for screening associated objects provided in the embodiments of the present application can be as shown in FIG. 1. FIG. 1 illustrates a schematic diagram of an application scenario for the method of screening associated objects provided in the embodiments of the present application. In FIG. 1, Image 1 represents a product image that includes the first product, while Image 2, Image 3, Image 4, and Image 5 represent product images that include different second products. Product Title 1 represents the title of the first product, while Product Title 2, Product Title 3, Product Title 4, and Product Title 5 represent the titles of different second products.

On the client side, for the currently selected product (hereinafter referred to as the first product), a product display page is generated and shown, with a “Product Recommendation” control configured. When the customer triggers the “Product Recommendation” control, the client generates a product recommendation request for the first product. In response to this request, the client obtains the first feature vector set corresponding to the first product and at least one second feature vector set corresponding to at least one second product. The first feature vector set records the image feature vector corresponding to the product image of the first product and the text feature vector corresponding to the product title of the first product. Similarly, the second feature vector set records the image feature vector corresponding to the product image of the second product and the text feature vector corresponding to the product title of the second product. Additionally, the image feature vectors and text feature vectors correspond to the same feature space.

After obtaining the first feature vector set and the second feature vector set, the client further calculates multiple vector similarities between the feature vectors in the first feature vector set and the feature vectors in the second feature vector set. The client then uses these multiple vector similarities to determine the product similarity between the first product and the second product. Among the multiple vector similarities, the vector similarity between the image feature vector and the text feature vector is included. Additionally, in most cases, the vector similarities between the image feature vectors of the two products and between the text feature vectors of the two products are also included.

After determining the product similarity, the client screens same style products for the first product from the at least one second product based on the product similarity and displays the same style products in the product recommendation interface. Specifically, when screening same style products from the at least one second product, the client can pre-configure a similarity threshold and determine the second products that meet or exceed the similarity threshold as same style products.

In the technical solution of this application, since the image feature vectors and text feature vectors in the feature vector set correspond to the same feature space, it becomes possible to calculate the vector similarity between the image feature vector of one product and the text feature vector of another product. This allows the vector similarity between the image feature vectors and the text feature vectors to be included when determining the product similarity between the first product and the second product based on multiple vector similarities between the feature vectors in the first feature vector set and the feature vectors in the second feature vector set.

Therefore, in the technical solution of this application, when determining product similarity, not only can the vector similarity between the image feature vectors of two products and the vector similarity between the text feature vectors of two products be utilized, but also the vector similarity between the image feature vectors and the text feature vectors. Since the image feature vector represents the product image, and the text feature vector represents the product title that describes the key characteristics of the product, determining product similarity using the vector similarity between the image feature vectors of two products, the vector similarity between the text feature vectors of two products, and the vector similarity between the image feature vectors and the text feature vectors can be viewed as determining similarity based on the similarity between the product images, the similarity between the product titles, and the similarity between the product image of one product and the product title of the other product. By combining image similarity, text similarity, and cross-modal similarity to determine product similarity, the resulting product similarity is more accurate, allowing for more precise screening of same style products for the first product.

Additionally, since the same style products to the first product can be more accurately filtered, the same style products displayed on the product recommendation interface often better match the user's shopping needs for the first product. In this way, displaying same style products on the product recommendation interface can provide customers with more options that meet their shopping needs, thereby offering a better shopping experience for customers.

In the embodiments of the present application, the method for screening associated objects provided can also be applied to the recommendation of same style products on the server side. In this case, the implementation process of the method for screening associated objects provided in the embodiments of the present application can be as shown in FIG. 2. FIG. 2 illustrates a schematic diagram of another application scenario for the method of screening associated objects provided in the embodiments of the present application.

After the server receives a same style product provision request sent by the merchant for the first product, it responds to the request by obtaining the first feature vector set corresponding to the first product and at least one second feature vector set corresponding to at least one second product. The first feature vector set contains the image feature vector corresponding to the product image of the first product and the text feature vector corresponding to the product title of the first product. Similarly, the second feature vector set contains the image feature vector corresponding to the product image of the second product and the text feature vector corresponding to the product title of the second product. Additionally, the image feature vectors and the text feature vectors correspond to the same feature space.

After obtaining the first feature vector set and the second feature vector set, the server further calculates multiple vector similarities between the feature vectors in the first feature vector set and the feature vectors in the second feature vector set. These multiple vector similarities are then used to determine the product similarity between the first product and the second product. The multiple vector similarities include the vector similarity between the image feature vectors and the text feature vectors. Additionally, in most cases, they also include the vector similarity between the image feature vectors of the two products and the vector similarity between the text feature vectors of the two products.

After determining the product similarity, the server screens the same style products of the first product from the at least one second product based on the product similarity. The server then provides the same style products to the merchant, allowing the merchant to compare the first product with the same style products and assess the advantages and disadvantages of the first product relative to the same style products.

In the technical solution of this application, since the image feature vectors and text feature vectors in the feature vector set correspond to the same feature space, it becomes possible to calculate the vector similarity between the image feature vector of one product and the text feature vector of another product. This allows the vector similarity between the image feature vectors and text feature vectors to be included when determining the product similarity between the first product and the second product based on multiple vector similarities between the feature vectors in the first feature vector set and the feature vectors in the second feature vector set.

Therefore, in the technical solution of this application, when determining product similarity, not only can the vector similarity between the image feature vectors of two products and the vector similarity between the text feature vectors of two products be utilized, but also the vector similarity between the image feature vectors and text feature vectors. Since the image feature vector represents the product image, and the text feature vector represents the product title that describes the key characteristics of the product, determining product similarity using the vector similarity between the image feature vectors of two products, the vector similarity between the text feature vectors of two products, and the vector similarity between the image feature vector and the text feature vector can be viewed as determining product similarity based on the similarity between the product images of two products, the similarity between the product titles of two products, and the similarity between the product image of one product and the product title of the other product. By combining image similarity, text similarity, and cross-modal similarity to determine product similarity, the resulting product similarity will have higher accuracy, thereby allowing for more precise screening of same style products for the first product.

Furthermore, since same style products for the first product can be screened more accurately, comparing the first product with the same style products will provide a more precise assessment of the advantages and disadvantages of the first product relative to the same style products, thereby offering a more accurate reflection of the first product's inherent strengths and weaknesses.

It should be noted that the above application example of the method for screening associated objects provided in the embodiments of the present application is for case of understanding and is not intended to limit the method for screening associated objects provided in the embodiments of the present application. Specifically, the application scenarios of the method for screening associated objects provided in the embodiments of the present application are not limited to any particular scenario.

Additionally, the screening solution for associated objects described in this application can be executed by various entities, including applications, services, instances, function modules in software form, virtual machines (VMs), or cloud servers. It can also be implemented by hardware devices (such as servers or terminal devices) or hardware chips with object screening functionality. Such hardware chips may include a Central Processing Unit (CPU), Graphics Processing Unit (GPU), Field Programmable Gate Array (FPGA), Neural-network Processing Unit (NPU), Artificial Intelligence (AI) acceleration cards, or Data Processing Unit (DPU), among others. The devices that implement the associated object screening can be deployed on local computing devices or cloud computing platforms that provide computing power, storage, and network resources. The cloud computing platform may provide services in various models such as Infrastructure as a Service (IaaS), Platform as a Service (PaaS), Software as a Service (SaaS), or Data as a Service (DaaS). For instance, when the platform provides the screening function as SaaS, the cloud computing platform utilizes its own computing resources to offer associated object screening functionality, and the specific application architecture can be designed according to service requirements.

Furthermore, the user information (including but not limited to user device information, personal information, etc.) and data (including but not limited to data used for analysis, storage, and display) involved in this application are all information and data authorized by the user or fully authorized by all relevant parties. The collection, use, and processing of the related data must comply with the relevant laws, regulations, and standards of the respective countries and regions. Additionally, appropriate options must be provided for users to select or edit their authorization or to refuse authorization.

The following describes the technical solutions of this application and how they address the aforementioned technical problems in detail through specific embodiments. The related technologies mentioned below, as optional solutions, can be combined with the technical solutions of the embodiments of this application in any manner, all of which fall within the scope of protection of the embodiments of this application. For identical or similar concepts or processes, further explanation may be omitted in some embodiments.

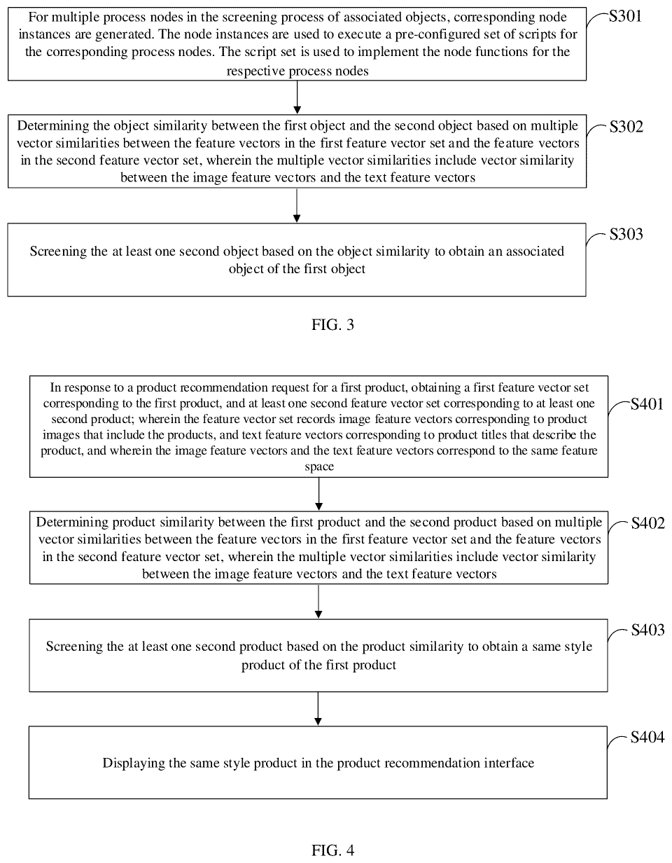

FIG. 3 illustrates a flowchart of a method 300 for screening associated objects provided in an embodiment of the present application. The method may include steps S301 to S303.

In S301, generating corresponding node instances for multiple process nodes in the screening process of associated objects; the node instances are used to execute a pre-configured set of scripts for the corresponding process nodes; the script set is used to implement the node functions for the respective process nodes.

Obtaining a first feature vector set corresponding to a first object, and at least one second feature vector set corresponding to at least one second object; the feature vector set records the image feature vectors corresponding to the object images, as well as the text feature vectors corresponding to the key characteristic description text that describes the key characteristics of the objects. The image feature vectors and the text feature vectors correspond to the same feature space.

Obtaining the first feature vector set and the second feature vector set refers to using the object image and the key characteristic description text corresponding to the first object to obtain the first feature vector set, and using the object image and the key characteristic description text corresponding to the second object to obtain the second feature vector set.

The object generally refers to a product, but it can also refer to exhibits, food, or other items. The second object is typically of the same type as the first object. In one example, the first object is an ergonomic chair, and the second object is also an ergonomic chair. In another example, the first object is a down jacket, and the second object is also a down jacket.

The key characteristics of the object are used to reflect its essential features. These key characteristics may include certain attributes of the object, as well as its advantages, sales strategy, sales performance, or its maintainability and repairability, among others. When the object is a product, the key characteristic description text that describes the object's key characteristics typically refers to the product title configured by the merchant.

In one example, the product title is “Manufacturer D Mold-Resistant Glass Glue for Kitchen and Bathroom Waterproof Scaling Silicone for Sinks and Toilets, Strong Edging Glue.” This product title includes three product attributes: the product type “edging gluc,” the manufacturer “Manufacturer D,” and the product function “glass glue for kitchen and bathroom waterproof sealing, silicone for sinks and toilets.” Additionally, it highlights two product advantages: “mold-resistant” and “strong.”

In another example, the product title is “Manufacturer E Hot and Sour Noodles Convenient Bulk Pack Authentic Sweet Potato Noodles 115 g*6 Bowls.” This product title includes three product attributes: the product type “hot and sour noodles,” the manufacturer “Manufacturer E,” and the quantity and weight “115 g*6 bowls.” Additionally, it highlights the product advantage “authentic sweet potato noodles” and the sales strategy “convenient bulk pack.”

The image feature vector is used to represent the object image that includes the object, while the text feature vector is used to represent the key characteristic description text that describes the object's key features. The image feature vector and the text feature vector corresponding to the same feature space means that they have the same vector dimensions and use the same numerical representation. In one example, both the image feature vector and the text feature vector are 1024-dimensional binary vectors.

In one possible implementation, to ensure that the image feature vector and text feature vector correspond to the same feature space, when obtaining the first feature vector set corresponding to the first object and at least one second feature vector set corresponding to at least one second object, feature extraction can first be performed on the object image and key characteristic description text corresponding to the first object in the predetermined feature space. This process generates the image feature vector and text feature vector corresponding to the first object, thereby constructing the first feature vector set. Similarly, feature extraction is performed on the object image and key characteristic description text corresponding to the second object in the predetermined feature space, generating the image feature vector and text feature vector corresponding to the second object and constructing the second feature vector set.

In the embodiments of this application, feature extraction from the object image and key characteristic description text corresponding to the first object in the predetermined feature space to obtain the image feature vector and text feature vector corresponding to the first object may involve first inputting the object image of the first object into a pre-trained image feature extraction model, obtaining the image feature vector output by this model as the image feature vector corresponding to the first object. Then, the key characteristic description text corresponding to the first object is input into a pre-trained text feature extraction model, and the text feature vector output by this model is obtained as the text feature vector corresponding to the first object. Correspondingly, for the second object, feature extraction from the object image and key characteristic description text in the predetermined feature space involves first inputting the object image of the second object into the pre-trained image feature extraction model, obtaining the image feature vector output by this model as the image feature vector corresponding to the second object. Then, the key characteristic description text corresponding to the second object is input into the pre-trained text feature extraction model, obtaining the text feature vector output by this model as the text feature vector corresponding to the second object.

Although the above method allows for obtaining the image feature vectors and text feature vectors corresponding to the first object and the second object, the software and hardware resources required to extract the image and text feature vectors are often considerable. To reduce the resource consumption while enhancing the representational capacity of the image and text feature vectors, a multimodal image-text model can be used to extract features from the object image and key characteristic description text, thereby obtaining the corresponding image and text feature vectors. In this case, feature extraction from the object image and key characteristic description text corresponding to the first object in the predetermined feature space involves inputting the object image and key characteristic description text of the first object into a pre-trained multimodal image-text model and obtaining the image and text feature vectors output by the model as the image and text feature vectors corresponding to the first object. Similarly, for the second object, feature extraction involves inputting the object image and key characteristic description text into the pre-trained multimodal image-text model and obtaining the image and text feature vectors output by the model as the image and text feature vectors corresponding to the second object.

Since the multimodal image-text model can better understand the relationships between images and text, the image and text feature vectors obtained through this model have stronger representational capabilities. Additionally, compared to separately training and deploying a neural network model for obtaining image feature vectors and another neural network model for obtaining text feature vectors, using a multimodal image-text model for feature extraction allows both the image and text feature vectors to be obtained simultaneously. This approach significantly reduces the software and hardware resources required for model training and deployment.

In the embodiments of this application, when the object is a product, before performing feature extraction from the object image and key characteristic description text corresponding to the first object in the predetermined feature space to obtain the image feature vector and text feature vector corresponding to the first object, the product title configured by the merchant for the first object needs to be obtained. The product title of the first object is then determined as the key characteristic description text corresponding to the first object. Similarly, before performing feature extraction from the object image and key characteristic description text corresponding to the second object in the predetermined feature space to obtain the image feature vector and text feature vector corresponding to the second object, the product title configured by the merchant for the second object needs to be obtained. The product title of the second object is then determined as the key characteristic description text corresponding to the second object. Generally, product titles describe some attributes of the product, as well as the product's advantages, sales strategy, sales performance, or its maintainability and repairability, among others. Therefore, product titles often reflect the key characteristics of a product. Based on this, when the object is a product, the product title can be determined as the key characteristic description text. This approach reduces the complexity of obtaining the key characteristic description text while ensuring that it accurately reflects the key characteristics of the product.

To ensure that the image and text feature vectors output by the multimodal image-text model can more accurately represent the object image and key characteristic description text, it is often necessary to use a large number of training samples to train the multimodal image-text model. The following example, where the object is a product, illustrates the process of obtaining a trained multimodal image-text model. When the object is a product, the key characteristic description text generally refers to the product title.

Firstly, obtain a general multimodal image-text model. Then, use a large number of product images and their corresponding product titles as training samples to initially train the general multimodal image-text model to obtain the first multimodal image-text model. Finally, use the product images and titles of selected products, along with the product images and titles of same style products, as training samples to further train the first multimodal image-text model. This process produces the second multimodal image-text model, which is then used as the trained multimodal image-text model.

In one example, the multimodal image-text model used is a BLIP2-based multimodal image-text model.

In one possible implementation, to reduce language differences and ambiguities between the key characteristic description texts of the first object and the second object, and to ensure that the vector similarity between the text feature vectors of the two objects more accurately reflects the similarity between their key characteristic description texts, the following process can be used: When performing feature extraction on the object image and key characteristic description text corresponding to the first object to obtain the image and text feature vectors of the first object, if the key characteristic description text of the first object is not in the specified language, it can first be translated into the specified language to obtain the first text. Then, feature extraction is performed on the first text and the object image of the first object to obtain the image and text feature vectors of the first object. Similarly, when performing feature extraction on the object image and key characteristic description text corresponding to the second object to obtain the image and text feature vectors of the second object, if the key characteristic description text of the second object is not in the specified language, it is first translated into the specified language to obtain the second text. Then, feature extraction is performed on the second text and the object image of the second object to obtain the image and text feature vectors of the second object.

In one example, the specified language is English, the key characteristic description text of the first object is in Chinese, and the key characteristic description texts of some second objects are in French, while others are in German. In this case, during the process of feature extraction on the object image and key characteristic description text corresponding to the first object to obtain the image and text feature vectors of the first object, the key characteristic description text of the first object must first be translated into English. Similarly, during the feature extraction process for the second objects, all key characteristic description texts of the second objects must first be translated into English before extracting their respective image and text feature vectors.

In the embodiments of this application, after obtaining the first feature vector set corresponding to the first object and at least one second feature vector set corresponding to at least one second object, S302 needs to be executed. In S302, determining the object similarity between the first object and the second object based on multiple vector similarities between the feature vectors in the first feature vector set and the feature vectors in the second feature vector set, wherein the multiple vector similarities include vector similarity between the image feature vectors and the text feature vectors.

The image feature vector represents the object image, while the text feature vector represents the key characteristic description text. Based on this, the vector similarity between the image feature vectors represents the similarity between the object images, the vector similarity between the text feature vectors represents the similarity between the key characteristic description texts, and the vector similarity between the image feature vector and the text feature vector represents the similarity between the object image and the key characteristic description text.

The vector similarity between the image feature vector and the text feature vector refers to the similarity between the image feature vector of one object and the text feature vector of another object. Specifically, this may include at least one of the following: the vector similarity between the image feature vector of the first object and the text feature vector of the second object, and the vector similarity between the text feature vector of the first object and the image feature vector of the second object.

The multiple vector similarities between the feature vectors in the first feature vector set and the feature vectors in the second feature vector set generally include: the vector similarity between the image feature vectors of the two objects, the vector similarity between the text feature vectors of the two objects, and the vector similarity between the image feature vectors and the text feature vectors. The multiple vector similarities may also include: the vector similarity between the text feature vectors of the two objects and the vector similarity between the image feature vectors and the text feature vectors. Additionally, the multiple vector similarities may include: the vector similarity between the image feature vectors of the two objects and the vector similarity between the image feature vectors and the text feature vectors.

In one possible implementation, to achieve higher accuracy in determining object similarity, the multiple vector similarities used to determine object similarity must include the vector similarity between the image feature vectors of the two objects, the vector similarity between the text feature vectors of the two objects, and the vector similarity between the image feature vector and the text feature vector. In other words, to achieve higher accuracy in determining object similarity, it is necessary to use the similarity between the object images of the two objects, the similarity between the key characteristic description texts of the two objects, and the similarity between the object image of one object and the key characteristic description text of the other object. Compared to determining object similarity based solely on image similarity or text similarity, or even based on both image and text similarity, determining object similarity by combining image similarity, text similarity, and cross-modal similarity provides higher accuracy. This, in turn, allows for more precise screening of associated objects for the first object.

In the process of determining object similarity between the first object and the second object using multiple vector similarities between the feature vectors in the first feature vector set and the feature vectors in the second feature vector set, similarity weights configured for the multiple vector similarities can be obtained first. Then, the object similarity is calculated using the multiple vector similarities and their corresponding similarity weights. Specifically, if the multiple vector similarities between the feature vectors in the first feature vector set and the feature vectors in the second feature vector set include the vector similarity between the text feature vectors of the two objects and the vector similarity between the image feature vectors and the text feature vectors, the formula for calculating the object similarity can be as follows:

$$P = W 1 * Q 1 + W 2 * Q 2$$

wherein, in this formula, P represents the object similarity, W1 represents the weight assigned to the vector similarity between the text feature vectors of the two objects, Q1 represents the vector similarity between the text feature vectors of the two objects, W2 represents the weight assigned to the vector similarity between the image feature vector and the text feature vector, and Q2 represents the vector similarity between the image feature vector and the text feature vector. Generally, Q1 is greater than Q2.

If the multiple vector similarities between the feature vectors in the first feature vector set and the feature vectors in the second feature vector set also include the vector similarity between the image feature vectors of the two objects and the vector similarity between the image feature vector and the text feature vector, then the formula for calculating the object similarity can be as follows:

$$P = W 3 * Q 3 + W 2 * Q 2$$

wherein, in this formula, P represents the object similarity, W2 represents the weight assigned to the vector similarity between the image feature vector and the text feature vector, Q2 represents the vector similarity between the image feature vector and the text feature vector, W3 represents the weight assigned to the vector similarity between the image feature vectors of the two objects, and Q3 represents the vector similarity between the image feature vectors of the two objects. Generally, Q3 is greater than Q2.

If the multiple vector similarities between the feature vectors in the first feature vector set and the feature vectors in the second feature vector set include the vector similarity between the image feature vectors of the two objects, the vector similarity between the text feature vectors of the two objects, and the vector similarity between the image feature vector and the text feature vector, then the formula for calculating the object similarity can be as follows:

$$P = W 1 * Q 1 + W 2 * Q 2 + W 3 * Q 3$$

wherein, in this formula, P represents the object similarity, W1 represents the weight assigned to the vector similarity between the text feature vectors of the two objects, Q1 represents the vector similarity between the text feature vectors of the two objects, W2 represents the weight assigned to the vector similarity between the image feature vector and the text feature vector, Q2 represents the vector similarity between the image feature vector and the text feature vector, W3 represents the weight assigned to the vector similarity between the image feature vectors of the two objects, and Q3 represents the vector similarity between the image feature vectors of the two objects. Generally, Q3>Q1>Q2.

In one possible implementation, during the process of determining the object similarity between the first object and the second object, the text similarity between the attribute description text of the first object and that of the second object can also be included. In this case, when determining the object similarity between the first object and the second object using multiple vector similarities between the feature vectors in the first feature vector set and those in the second feature vector set, the text similarity between the attribute description text of the first object and the attribute description text of the second object can be obtained first. Then, the object similarity is calculated based on the multiple vector similarities and the text similarity.

The attribute description text is used to describe the attribute information corresponding to the object. The attribute information includes the object's name, brand, color, type, size, weight, performance, and other relevant characteristics.

Since the attribute information of an object provides detailed information about the object, the attribute description texts corresponding to different objects can more precisely distinguish the similarities and differences between them. Based on this, including the similarity between the attribute description texts of different objects in the calculation of object similarity allows for a more accurate determination of object similarity.

In one example, Brand F sells two types of outdoor jackets that are same style in all attributes except for size. Both jackets have the product title “Brand F Winter Fleece-Lined Outdoor Jacket,” and the product images are the same for both. In this case, if only multiple vector similarities are used to calculate the object similarity, the object similarity might be 100%. However, if the similarity between the attribute description texts of the different objects is also included in the object similarity calculation, the difference in size between the two jackets will result in a lower text similarity. Consequently, the object similarity calculated based on both the multiple vector similarities and the text similarity is likely to be less than 100%.

In one example, before obtaining the text similarity between the attribute description text of the first object and the attribute description text of the second object, the attribute information corresponding to the first object and the attribute information corresponding to the second object can first be obtained. Then, following a specified document structure, the attribute information for the first object and the second object is described to obtain the attribute description text for the first object and the attribute description text for the second object.

Describing the attribute information of the first object and the second object according to a specified document structure helps ensure consistency between the attribute description texts of the first object and the second object.

When the object is a product, the specified document structure can refer to the CPV (Category-Property-Value) structure.

When calculating object similarity based on multiple vector similarities and text similarity, corresponding similarity weights can first be assigned to each of the vector similarities and the text similarity. Then, the respective similarity weights for the multiple vector similarities and the text similarity are obtained. The object similarity is calculated using the multiple vector similarities with their corresponding similarity weights, as well as the text similarity with its corresponding similarity weight.

If the multiple vector similarities include: the vector similarity between the image feature vectors of the two objects, the vector similarity between the text feature vectors of the two objects, and the vector similarity between the image feature vector and the text feature vector, then the formula for calculating the object similarity can be as follows:

$$P = W 1 * Q 1 + W 2 * Q 2 + W 3 * Q 3 + W 4 * Q 4$$

wherein, in this formula, P represents the object similarity, W/represents the weight assigned to the vector similarity between the text feature vectors of the two objects, Q1 represents the vector similarity between the text feature vectors of the two objects, W2 represents the weight assigned to the vector similarity between the image feature vector and the text feature vector, Q2 represents the vector similarity between the image feature vector and the text feature vector, W3 represents the weight assigned to the vector similarity between the image feature vectors of the two objects, Q3 represents the vector similarity between the image feature vectors of the two objects, W4 represents the weight assigned to the text similarity, and Q4 represents the text similarity. Generally, Q3>Q1>Q2>Q4.

In the embodiments of this application, after determining the object similarity between the first object and the second object using the multiple vector similarities between the feature vectors in the first feature vector set and the feature vectors in the second feature vector set, S303 is further executed. In S303, screening the at least one second object based on the object similarity to obtain an associated object of the first object.

An associated object refers to an object that has the same or similar form, style, design features, or functionality as the first object. When the object is a product, the associated object refers to a same style product. In one example, the first object is a pair of thick Martin boots sold by Merchant H. In this case, the associated objects could be other thick Martin boots sold by Merchant H, as well as thick Martin boots sold by other merchants. Here, the common design feature between the first object and the associated objects is the “thickened” design.

In one example, screening the at least one second object based on object similarity to obtain an associated object of the first object means first obtaining a pre-configured similarity threshold. Then using the similarity threshold and the object similarity, the associated object is screened from at least one second object.

In another example, screening the at least one second object based on object similarity to obtain an associated object of the first object means first obtaining a pre-configured similarity threshold. Then using the similarity threshold and the object similarity, a specified number of associated objects are screened from at least one second object.

In the method for screening associated objects provided in the embodiments of this application, since the image feature vectors and text feature vectors in the feature vector set correspond to the same feature space, it becomes possible to calculate the vector similarity between the image feature vector of one object and the text feature vector of another object. In this way, when determining the object similarity between the first object and the second object based on multiple vector similarities between the feature vectors in the first feature vector set and the second feature vector set, the vector similarity between the image feature vectors and the text feature vectors can also be included into the process.

Therefore, the method for screening associated objects provided in this embodiment not only uses the vector similarity between the image feature vectors of two objects and the vector similarity between the text feature vectors of two objects to determine object similarity, but also includes the vector similarity between the image feature vector and the text feature vector. Since the image feature vector represents the object image, and the text feature vector represents the key characteristic description text, determining object similarity using the vector similarity between the image feature vectors, the text feature vectors, and between the image and text feature vectors can be seen as determining similarity based on the similarity between the object images, the similarity between the key characteristic description texts, and the similarity between the object image of one object and the key characteristic description text of another object. By combining image similarity, text similarity, and cross-modal similarity to determine object similarity, the method achieves higher accuracy in determining object similarity, thereby enabling more precise screening of associated objects for the first object.

Corresponding to the application example of the method provided in this embodiment and the method for screening associated objects, the present embodiment also provides a method for recommending same style products. As shown in FIG. 4, it illustrates a flowchart of a method 400 for recommending same style products provided in this embodiment. This method may include steps S401 to S304.

In S401, in response to a product recommendation request for a first product, obtaining a first feature vector set corresponding to the first product, and at least one second feature vector set corresponding to at least one second product. The feature vector sets records image feature vectors corresponding to product images that include the products, and the text feature vectors corresponding to product titles that describe the products, and the image feature vectors and text feature vectors correspond to the same feature space.

The image feature vector represents the object image that includes the object, while the text feature vector represents the key characteristic description text that describes the object's key features. The image feature vector and text feature vector corresponding to the same feature space means that they have the same vector dimensions and use the same numerical representation format.

In S402, determining product similarity between the first product and the second product based on multiple vector similarities between the feature vectors in the first feature vector set and the feature vectors in the second feature vector set. These multiple vector similarities include vector similarity between the image feature vectors and the text feature vectors.

The image feature vector represents the product image that includes the product, while the text feature vector represents the key characteristic description text that describes the product's key features. Based on this, the vector similarity between the image feature vectors represents the similarity between the product images, the vector similarity between the text feature vectors represents the similarity between the product titles, and the vector similarity between the image feature vector and the text feature vector represents the similarity between the product image and the product title.

The vector similarity between the image feature vector and the text feature vector refers to the similarity between the image feature vector of one product and the text feature vector of another product. Specifically, this may include at least one of the following: the vector similarity between the image feature vector of the first product and the text feature vector of the second product, and the vector similarity between the text feature vector of the first product and the image feature vector of the second product.

In S403, screening the at least one second product based on the product similarity to obtain a same style product of the first product.

Screening the at least one second product based on product similarity to obtain an associated product of the first product means first obtaining a pre-configured similarity threshold. Then, using the similarity threshold and the product similarity, the associated product is obtained from at least one second product.

In S404, displaying the same style product in the product recommendation interface.

In the same style product recommendation method provided in this embodiment, since the image feature vectors and text feature vectors in the feature vector set correspond to the same feature space, it becomes possible to calculate the vector similarity between the image feature vector of one product and the text feature vector of another product. In this way, when determining the product similarity between the first product and the second product using multiple vector similarities between the feature vectors in the first and second feature vector sets, the vector similarity between the image feature vectors and text feature vectors can also be included in the process.

Therefore, in the same style product recommendation method provided in this embodiment, when determining product similarity, not only can the vector similarity between the image feature vectors of two products and the vector similarity between the text feature vectors of two products be utilized, but also the vector similarity between the image feature vectors and the text feature vectors. Since the image feature vector represents the product image and the text feature vector represents the product title that describes the key characteristics of the product, determining product similarity based on the vector similarity between the image feature vectors, the text feature vectors, and the image and text feature vectors can be understood as determining similarity based on the similarity between the product images, the similarity between the product titles, and the similarity between the product image of one product and the product title of another product. By combining image similarity, text similarity, and cross-modal similarity, this approach ensures higher accuracy in determining product similarity, thereby allowing for more precise identification of same style products for the first product.

Additionally, since the same style products for the first product can be more accurately identified, the same style products displayed on the product recommendation interface are more likely to meet the user's shopping needs for the first product. As a result, displaying same style products on the recommendation interface provides customers with more choices that align with their shopping preferences, thereby enhancing the overall shopping experience.

Corresponding to the application example of the method provided in this embodiment and the method for screening associated objects, this embodiment also provides another method for recommending same style products. As shown in FIG. 5, it illustrates a flowchart of another same style product recommendation method 500 provided in this embodiment. This method may include S501 to S504.

In S501, in response to a same style product provision request for a first product sent by a merchant, obtaining a first feature vector set corresponding to the first product and at least one second feature vector set corresponding to at least one second product. The feature vector sets record image feature vectors corresponding to product images that include the products, and text feature vectors corresponding to the product titles that describe the products. The image feature vectors and text feature vectors correspond to the same feature space.

The image feature vector represents the object image that includes the object, while the text feature vector represents the key characteristic description text that describes the object's key features. When the image feature vectors and text feature vectors correspond to the same feature space, it means that they share the same vector dimensions and use the same numerical representation format.

In S502, determining product similarity between the first product and the second product based on multiple vector similarities between the feature vectors in the first feature vector set and the feature vectors in the second feature vector set. These multiple vector similarities include vector similarity between the image feature vectors and the text feature vectors.

The image feature vector represents the product image that includes the product, while the text feature vector represents the key characteristic description text that describes the product's key features. Based on this, the vector similarity between the image feature vectors represents the similarity between the product images, the vector similarity between the text feature vectors represents the similarity between the product titles, and the vector similarity between the image feature vector and the text feature vector represents the similarity between the product image and the product title.

The vector similarity between the image feature vector and the text feature vector refers to the similarity between the image feature vector of one product and the text feature vector of another product. Specifically, this can include at least one of the following: the vector similarity between the image feature vector of the first product and the text feature vector of the second product, and the vector similarity between the text feature vector of the first product and the image feature vector of the second product.

In S503, screening the at least one second product based on the product similarity to obtain a same style product of the first product.

Screening the at least one second product based on product similarity to obtain an associated product of the first product means first obtaining a pre-configured similarity threshold. Then, using the similarity threshold and the product similarity, the associated product is obtained from screening at least one second product.

In S504, providing the same style products to the merchant.

In the same style product recommendation method provided by this embodiment, since the image feature vectors and text feature vectors in the feature vector set correspond to the same feature space, it is possible to calculate the vector similarity between the image feature vector of one product and the text feature vector of another product. This way, when determining the product similarity between the first product and the second product using multiple vector similarities between the feature vectors in the first and second feature vector sets, the vector similarity between the image feature vectors and the text feature vectors is also included into the process.

Therefore, in the same style product recommendation method provided by this embodiment, when determining product similarity, in addition to using the vector similarity between the image feature vectors of two products and the vector similarity between the text feature vectors of two products, the vector similarity between the image feature vector and the text feature vector can also be used. Since the image feature vector represents the product image, and the text feature vector represents the product title that describes the key features of the product, determining product similarity by using the vector similarity between the image feature vectors, the vector similarity between the text feature vectors, and the vector similarity between the image and text feature vectors can be understood as determining similarity based on the similarity between the product images, the similarity between the product titles, and the similarity between the product image of one product and the product title of another product. By combining image similarity, text similarity, and cross-modal similarity, this method ensures higher accuracy in determining product similarity, thereby enabling a more precise identification of same style products for the first product.

Furthermore, since the same style products for the first product can be more accurately identified, comparing the first product with the same style products provides a more precise assessment of the advantages and disadvantages of the first product relative to the same style products. This results in a more accurate reflection of the first product's own strengths and weaknesses.

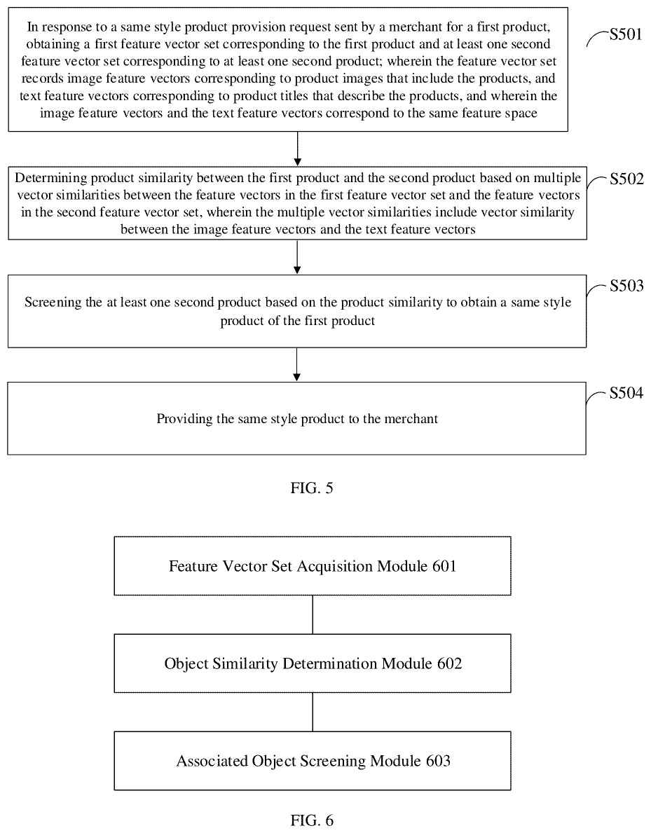

Corresponding to the application example of the method provided in this embodiment and the method for screening associated objects, this embodiment also provides a device for screening associated objects. As shown in FIG. 6, it is a structural block diagram of the associated object screening device 600 provided in this embodiment. The device 600 may include:
a feature vector set acquisition module 601, which is configured to obtain the first feature vector set corresponding to the first object, and at least one second feature vector set corresponding to at least one second object. The feature vector set includes the image feature vector corresponding to the object image and the text feature vector corresponding to the key characteristic description text that describes the key features of the object. The image feature vectors and text feature vectors correspond to the same feature space;
an object similarity determination module 602, which is used to determine the object similarity between the first object and the second object based on multiple vector similarities between the feature vectors in the first feature vector set and the feature vectors in the second feature vector set, wherein the multiple vector similarities include the vector similarity between the image feature vectors and the text feature vectors;
an associated object screening module 603, which is used to screen the associated object of the first object from at least one second object based on the object similarity.

In one possible implementation, the feature vector set acquisition module 601 includes:
a first feature vector set construction sub-module, which is used to extract features from the object image and key characteristic description text corresponding to the first object in the predetermined feature space, obtaining the image feature vector and text feature vector corresponding to the first object, and constructing the first feature vector set;
a second feature vector set construction sub-module, which is used to extract features from the object image and key characteristic description text corresponding to the second object in the predetermined feature space, obtaining the image feature vector and text feature vector corresponding to the second object, and constructing the second feature vector set.

In one possible implementation, the first feature vector set construction sub-module includes:
a first text conversion sub-module, which is used to convert the key characteristic description text of the first object into the specified language when the key characteristic description text of the first object is not in the specified language, thereby obtaining the first text;
a first feature vector extraction sub-module, which is used to extract features from the first text and the object image corresponding to the first object, obtaining the image feature vector and text feature vector corresponding to the first object;
the second feature vector set construction sub-module includes:
a second text conversion sub-module, which is used to convert the key characteristic description text of the second object into the specified language when the key characteristic description text of the second object is not in the specified language, thereby obtaining the second text;
a second feature vector extraction sub-module, which is used to extract features from the second text and the object image corresponding to the second object, obtaining the image feature vector and text feature vector corresponding to the second object.

In one possible implementation, the first feature vector set construction sub-module includes:
a third feature vector extraction sub-module, which is used to input the object image and key characteristic description text corresponding to the first object into a pre-trained multimodal image-text model, obtaining the image feature vector and text feature vector output by the model as the image feature vector and text feature vector corresponding to the first object.

In one possible implementation, the object includes a product; the device further includes:
a product title acquisition module, which is used to obtain the product title configured by the merchant for the first object before performing feature extraction on the object image and key characteristic description text corresponding to the first object in the predetermined feature space to obtain the image feature vector and text feature vector corresponding to the first object.
a key characteristic description text determination module, which is used to determine the product title corresponding to the first object as the key characteristic description text for the first object.

In one possible implementation, the object similarity determination module 602 includes:
a similarity weight acquisition sub-module, which is used to obtain the similarity weights configured for the multiple vector similarities;
a first similarity calculation sub-module, which is used to calculate the object similarity by utilizing the multiple vector similarities and their corresponding similarity weights.

In one possible implementation, the multiple vector similarities also include the vector similarity between the image feature vector of the first object and the image feature vector of the second object, as well as the vector similarity between the text feature vector of the first object and the text feature vector of the second object.

In one possible implementation, the object similarity determination module 602 includes:
a text similarity acquisition sub-module, which is used to obtain the text similarity between the attribute description text corresponding to the first object and the attribute description text corresponding to the second object;
a second similarity calculation sub-module, which is used to calculate the object similarity based on multiple vector similarities and the text similarity.

In one possible implementation, the device further includes:
an attribute information acquisition module, which is used to obtain the attribute information corresponding to the first object and the attribute information corresponding to the second object before obtaining the text similarity between the attribute description text of the first object and the attribute description text of the second object;
an attribute description text acquisition module is used to describe the attribute information corresponding to the first object and the second object according to a specified document structure to obtain the attribute description text for the first object and the attribute description text for the second object.

In one possible implementation, the associated object screening module 603 includes:
a similarity threshold acquisition sub-module, which is used to obtain a pre-configured similarity threshold;
an associated object screening sub-module, which is used to screen the associated object from at least one second object based on the similarity threshold and the object similarity.

The functions of each module in the devices of this embodiment can refer to the corresponding descriptions in the above-mentioned methods and possess the corresponding beneficial effects. Therefore, they will not be repeated here.

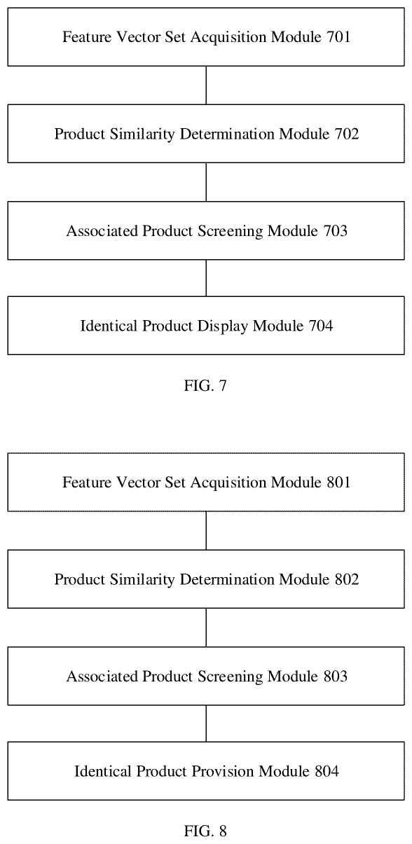

Corresponding to the application example of the method provided in this embodiment and the first same style product recommendation method, this embodiment also provides a device for recommending same style products. As shown in FIG. 7, it is a structural block diagram of the same style product recommendation device 700 provided in this embodiment. The device 700 may include:
a feature vector set acquisition module 701, which is used to respond to a product recommendation request for the first product by obtaining the first feature vector set corresponding to the first product and at least one second feature vector set corresponding to at least one second product. The feature vector sets record the image feature vectors corresponding to the product images and the text feature vectors corresponding to the product titles. The image feature vectors and text feature vectors correspond to the same feature space;
a product similarity determination module 702, which is used to determine the product similarity between the first product and the second product by utilizing multiple vector similarities between the feature vectors in the first feature vector set and the feature vectors in the second feature vector set. These multiple vector similarities include the vector similarity between the image feature vectors and the text feature vectors;
an associated product screening module 703, which is used to screen the same style product to the first product from at least one second product based on the product similarity;
a same style product display module 704, which is used to display the same style product on the product recommendation interface.

The functions of each module in the devices of this embodiment correspond to the descriptions provided in the aforementioned methods and yield the corresponding beneficial effects. Therefore, will not repeated.

Corresponding to the application example of the method provided in this embodiment and the second same style product recommendation method, this embodiment also provides another same style product recommendation device. As shown in FIG. 8, it is a structural block diagram of another same style product recommendation device 800 provided in this embodiment. The device 800 may include:
a feature vector set acquisition module 801, which is used to respond to a request from the merchant for same style product recommendations for the first product by obtaining the first feature vector set corresponding to the first product, as well as at least one second feature vector set corresponding to at least one second product. The feature vector sets include the image feature vectors corresponding to the product images and the text feature vectors corresponding to the product titles. The image feature vectors and text feature vectors correspond to the same feature space;
a product similarity determination module 802, which is used to determine the product similarity between the first product and the second product by utilizing multiple vector similarities between the feature vectors in the first feature vector set and the feature vectors in the second feature vector set. These multiple vector similarities include the vector similarity between the image feature vectors and the text feature vectors;
an associated product screening module 803, which is used to screen the same style product to the first product from at least one second product based on the product similarity.

The same style product provision module 804 is used to provide the same style product to the merchant.

The functions of each module in the devices of this embodiment correspond to the descriptions provided in the aforementioned methods and yield the corresponding beneficial effects. Therefore, further elaboration is omitted.

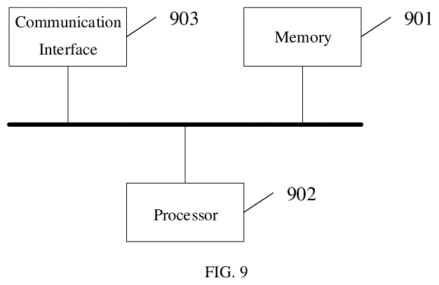

FIG. 9 illustrates a block diagram of an electronic device used to implement the embodiments of this application. As shown in FIG. 9, the electronic device includes: a memory 901 and a processor 902, where the memory 901 stores a computer program that can run on the processor 902. When the processor 902 executes the computer program, it implements the methods described in the above embodiments. The number of memory 901 and processor 902 components can be one or more.

The electronic device further includes:
a communication interface 903, used for communication with external devices and for data exchange and transmission.

If the memory 901, processor 902, and communication interface 903 are implemented separately, they can be interconnected through a bus for communication. The bus can be an Industry Standard Architecture (ISA) bus, Peripheral Component Interconnect (PCI) bus, or Extended Industry Standard Architecture (EISA) bus, among others. The bus may be divided into address buses, data buses, control buses, etc. For simplicity, only one thick line is shown in FIG. 9 to represent the bus, but this does not imply that there is only one bus or only one type of bus.

Alternatively, in specific implementations, if the memory 901, processor 902, and communication interface 903 are integrated onto a single chip, they can communicate with each other via internal interfaces.

This embodiment of the application provides a computer-readable storage medium that stores a computer program. When executed by the processor, the program implements the method provided in the embodiments of this application.

This embodiment of the application also provides a chip, which includes a processor used to retrieve and execute instructions stored in the memory. This allows the communication device equipped with the chip to execute the method provided in the embodiments of this application.

This embodiment of the application also provides a chip, which includes: an input interface, an output interface, a processor, and a memory. The input interface, output interface, processor, and memory are connected via internal connection paths. The processor is used to execute the code stored in the memory, and when the code is executed, the processor implements the method provided in the embodiments of this application.

It should be understood that the processor mentioned above can be a Central Processing Unit (CPU) or other general-purpose processors, Digital Signal Processors (DSP), Application Specific Integrated Circuits (ASIC), Field Programmable Gate Arrays (FPGA), or other programmable logic devices, discrete gate or transistor logic devices, or other discrete hardware components. The general-purpose processor can be a microprocessor or any conventional processor. It is worth noting that the processor can also be one that supports the Advanced RISC Machines (ARM) architecture.

Furthermore, optionally, the memory may include read-only memory (ROM) and random access memory (RAM), and may also include non-volatile random access memory (NVRAM). The memory can be either volatile or non-volatile, or may include both types of memory. Non-volatile memory may include ROM, programmable ROM (PROM), erasable programmable ROM (EPROM), electrically erasable programmable ROM (EEPROM), or flash memory. Volatile memory may include RAM, which is used as external cache. By way of example, but not limitation, various forms of RAM may be used, such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and Direct Rambus RAM (DRRAM).

In the above embodiments, the implementation may be entirely or partially achieved through software, hardware, firmware, or any combination thereof. When implemented using software, it can be realized entirely or partially in the form of a computer program product. The computer program product includes one or more computer instructions. When loaded and executed on a computer, these program instructions generate, either in whole or in part, the processes or functions described in this application. The computer can be a general-purpose computer, a specialized computer, a computer network, or other programmable devices. The computer instructions may be stored in a computer-readable storage medium or transmitted from one computer-readable storage medium to another.

In the description of this specification, references to terms such as “one embodiment,” “some embodiments,” “example,” “specific example,” or “certain examples” mean that the specific features, structures, materials, or characteristics described in connection with that embodiment or example are included in at least one embodiment or example of this application. Furthermore, the described specific features, structures, materials, or characteristics may be combined in any suitable way in one or more embodiments or examples. Additionally, where not contradictory, those skilled in the art may combine and integrate different embodiments or examples, as well as features of different embodiments or examples described in this specification.

Additionally, the terms “first” and “second” are used merely for descriptive purposes and should not be interpreted as indicating or implying relative importance or suggesting a specific number of the referenced technical features. Thus, features designated as “first” or “second” may explicitly or implicitly include at least one of those features. In the context of this application, “multiple” refers to two or more, unless explicitly stated otherwise.

Any process or method described in the flowcharts or otherwise in this document can be understood as representing executable instructions in the form of modules, segments, or parts that include one or more steps for implementing a specific logical function or process. Furthermore, the scope of the preferred embodiments of this application includes alternative implementations in which the functions may be performed in a different order than shown or discussed, including executing the functions substantially simultaneously or in reverse order, depending on the functions involved.

The logic and/or steps represented in the flowcharts or otherwise described herein can be considered as sequences of executable instructions for implementing logical functions. These sequences can be embodied in any computer-readable medium for use by, or in conjunction with, an instruction execution system, device, or apparatus (such as a computer-based system, a system that includes a processor, or any other system capable of retrieving and executing instructions from such a system, device, or apparatus).

It should be understood that various components of this application can be implemented using hardware, software, firmware, or a combination thereof. In the embodiments described above, multiple steps or methods can be implemented using software or firmware stored in memory and executed by an appropriate instruction execution system. All or part of the steps of the aforementioned method embodiments can be carried out by hardware as directed by a program, which can be stored in a computer-readable storage medium. When executed, the program includes one or more steps of the method embodiments or their combinations.

Additionally, the functional units in the various embodiments of this application can either be integrated into a single processing module, exist independently as separate physical units, or be integrated into one module as two or more units. The integrated module may be implemented in hardware or as software functional modules. If the integrated module is implemented as a software functional module and sold or used as an independent product, it can also be stored on a computer-readable storage medium, such as read-only memory, a magnetic disk, or an optical disk.

The above descriptions are merely specific embodiments of this application, and the scope of protection is not limited to these. Any person skilled in the art, within the scope of the technology disclosed in this application, can easily conceive of various changes or substitutions, all of which should be included within the scope of protection of this application. Therefore, the scope of protection should be determined by the claims.

What is claimed is:

1. A method for screening associated objects, comprising:
obtaining a first feature vector set corresponding to a first object and at least one second feature vector set corresponding to at least one second object, wherein the feature vector set records image feature vectors corresponding to object images that include the objects, and text feature vectors corresponding to key characteristic description text that describes key characteristics of the objects, and wherein the image feature vectors and the text feature vectors correspond to the same feature space;
determining an object similarity between the first object and the second object based on multiple vector similarities between the feature vectors in the first feature vector set and the feature vectors in the second feature vector set, wherein the multiple vector similarities include vector similarity between the image feature vectors and the text feature vectors;
screening the at least one second object based on the object similarity to obtain an associated object of the first object.

2. The method according to claim 1, wherein the obtaining of the first feature vector set corresponding to the first object, and the obtaining of the second feature vector set corresponding to at least one second object, comprises:
in a predetermined feature space, performing feature extraction on an object image and key characteristic description text corresponding to the first object to obtain an image feature vector and a text feature vector corresponding to the first object, and constructing the first feature vector set;
in the predetermined feature space, performing feature extraction on an object image and key characteristic description text corresponding to the second object to obtain an image feature vector and a text feature vector corresponding to the second object, and constructing the second feature vector set.

3. The method according to claim 2, wherein, in a predetermined feature space, performing feature extraction on an object image and key characteristic description text corresponding to the first object to obtain an image feature vector and a text feature vector corresponding to the first object comprises:
when the key characteristic description text corresponding to the first object does not belong to specified language text, converting the key characteristic description text corresponding to the first object into the specified language text to obtain first text;
performing feature extraction on the first text and the object image corresponding to the first object to obtain the image feature vector and the text feature vector corresponding to the first object;
wherein in the predetermined feature space, performing feature extraction on an object image and key characteristic description text corresponding to the second object to obtain an image feature vector and a text feature vector corresponding to the second object comprises:
when the key characteristic description text corresponding to the second object does not belong to specified language text, converting the key characteristic description text corresponding to the second object into the specified language text to obtain second text;
performing feature extraction on the second text and the object image corresponding to the second object to obtain the image feature vector and the text feature vector corresponding to the second object.

4. The method according to claim 2, wherein, in a predetermined feature space, performing feature extraction on an object image and key characteristic description text corresponding to the first object to obtain an image feature vector and a text feature vector corresponding to the first object comprises:
inputting the object image and the key characteristic description text corresponding to the first object into a trained image-text multimodal model, and obtaining the image feature vector and the text feature vector output by the image-text multimodal model as the image feature vector and the text feature vector corresponding to the first object.

5. The method according to claim 4, wherein the object comprises a product, and prior to, in a predetermined feature space, performing feature extraction on an object image and key characteristic description text corresponding to the first object to obtain an image feature vector and a text feature vector corresponding to the first object, the method further comprises:
obtaining a product title configured by a merchant for the first object;
determining the product title corresponding to the first object as the key characteristic description text corresponding to the first object.

6. The method according to claim 1, wherein determining the object similarity between the first object and the second object based on multiple vector similarities between the feature vectors in the first feature vector set and the feature vectors in the second feature vector set comprises:
obtaining similarity weights configured for the multiple vector similarities;
calculating the object similarity using the multiple vector similarities and the similarity weights corresponding to each vector similarity.

7. The method according to claim 6, wherein the multiple vector similarities further comprise:
the vector similarity between the image feature vector corresponding to the first object and the image feature vector corresponding to the second object; and
the vector similarity between the text feature vector corresponding to the first object and the text feature vector corresponding to the second object.

8. The method according to claim 1, wherein determining the object similarity between the first object and the second object based on multiple vector similarities between the feature vectors in the first feature vector set and the feature vectors in the second feature vector set comprises:
obtaining a text similarity between attribute description text corresponding to the first object and attribute description text corresponding to the second object;
calculating the object similarity based on the multiple vector similarities and the text similarity.

9. The method according to claim 8, wherein, prior to obtaining the text similarity between the attribute description text corresponding to the first object and the attribute description text corresponding to the second object, the method further comprises:
obtaining attribute information corresponding to the first object and attribute information corresponding to the second object;
describing the attribute information corresponding to the first object and the attribute information corresponding to the second object according to a specified document structure to obtain the attribute description text corresponding to the first object and the attribute description text corresponding to the second object.

10. The method according to claim 1, wherein screening the at least one second object based on the object similarity to obtain the associated object of the first object from comprises:
obtaining a pre-configured similarity threshold;
screening the at least one second object based on the similarity threshold and the object similarity to obtain the associated object.

11. A method for recommending same style products, comprising:
in response to a product recommendation request for a first product, obtaining a first feature vector set corresponding to the first product, and at least one second feature vector set corresponding to at least one second product,
wherein the feature vector set records image feature vectors corresponding to product images that include the products, and text feature vectors corresponding to product titles that describe the products, and wherein the image feature vectors and the text feature vectors correspond to the same feature space;
determining product similarity between the first product and the second product based on multiple vector similarities between the feature vectors in the first feature vector set and the feature vectors in the second feature vector set, wherein the multiple vector similarities include vector similarity between the image feature vectors and the text feature vectors;
screening the at least one second product based on the product similarity to obtain a same style product of the first product;
displaying the same style product in the product recommendation interface.

12. The method according to claim 11, wherein the obtaining of the first feature vector set corresponding to the first product, and the obtaining of the second feature vector set corresponding to at least one second product, comprises:
in a predetermined feature space, performing feature extraction on an product image and key characteristic description text corresponding to the first product to obtain an image feature vector and a text feature vector corresponding to the first product, and constructing the first feature vector set;
in the predetermined feature space, performing feature extraction on an product image and key characteristic description text corresponding to the second product to obtain an image feature vector and a text feature vector corresponding to the second product, and constructing the second feature vector set.

13. The method according to claim 12, wherein, in a predetermined feature space, performing feature extraction on an product image and key characteristic description text corresponding to the first product to obtain an image feature vector and a text feature vector corresponding to the first product comprises:
when the key characteristic description text corresponding to the first product does not belong to specified language text, converting the key characteristic description text corresponding to the first product into the specified language text to obtain first text;
performing feature extraction on the first text and the product image corresponding to the first product to obtain the image feature vector and the text feature vector corresponding to the first product;
wherein in the predetermined feature space, performing feature extraction on an product image and key characteristic description text corresponding to the second product to obtain an image feature vector and a text feature vector corresponding to the second product comprises:
when the key characteristic description text corresponding to the second product does not belong to specified language text, converting the key characteristic description text corresponding to the second product into the specified language text to obtain second text;
performing feature extraction on the second text and the product image corresponding to the second product to obtain the image feature vector and the text feature vector corresponding to the second product.

14. The method according to claim 12, wherein, in a predetermined feature space, performing feature extraction on an product image and key characteristic description text corresponding to the first product to obtain an image feature vector and a text feature vector corresponding to the first product comprises:
inputting the product image and the key characteristic description text corresponding to the first product into a trained image-text multimodal model, and obtaining the image feature vector and the text feature vector output by the image-text multimodal model as the image feature vector and the text feature vector corresponding to the first product.

15. The method according to claim 14, wherein the product comprises a product, and prior to, in a predetermined feature space, performing feature extraction on an product image and key characteristic description text corresponding to the first product to obtain an image feature vector and a text feature vector corresponding to the first product, the method further comprises:
obtaining a product title configured by a merchant for the first product;
determining the product title corresponding to the first product as the key characteristic description text corresponding to the first product.

16. A method for recommending same style products, comprising:
in response to a same style product provision request sent by a merchant for a first product, obtaining a first feature vector set corresponding to the first product and at least one second feature vector set corresponding to at least one second product,
wherein the feature vector set records image feature vectors corresponding to product images that include the products, and text feature vectors corresponding to product titles that describe the products, and wherein the image feature vectors and the text feature vectors correspond to the same feature space;
determining product similarity between the first product and the second product based on multiple vector similarities between the feature vectors in the first feature vector set and the feature vectors in the second feature vector set, wherein the multiple vector similarities include vector similarity between the image feature vectors and the text feature vectors;
screening the at least one second product based on the product similarity to obtain a same style product of the first product;
providing the same style product to the merchant.

17. The method according to claim 16, wherein determining the product similarity between the first product and the second product based on multiple vector similarities between the feature vectors in the first feature vector set and the feature vectors in the second feature vector set comprises:
obtaining similarity weights configured for the multiple vector similarities;
calculating the product similarity using the multiple vector similarities and the similarity weights corresponding to each vector similarity.

18. The method according to claim 17, wherein the multiple vector similarities further comprise:
the vector similarity between the image feature vector corresponding to the first product and the image feature vector corresponding to the second product; and
the vector similarity between the text feature vector corresponding to the first product and the text feature vector corresponding to the second product.

19. The method according to claim 16, wherein determining the product similarity between the first product and the second product based on multiple vector similarities between the feature vectors in the first feature vector set and the feature vectors in the second feature vector set comprises:
obtaining a text similarity between attribute description text corresponding to the first product and attribute description text corresponding to the second product;
calculating the product similarity based on the multiple vector similarities and the text similarity.

20. The method according to claim 16, wherein screening the at least one second product based on the product similarity to obtain the associated product of the first product from comprises:
obtaining a pre-configured similarity threshold;
screening the at least one second product based on the similarity threshold and the product similarity to obtain the associated product.
